(19) United States
(12) Patent Application Publication
(10) Pub. No.: US 2006/0055641 A1
(43) Pub. Date: Mar. 16, 2006

(54) Led billboard controller with integrated sign interface module

(75) Inventors: Bryan L. Robertus, Bozeman, MT (US); Jason A. Daughenbaugh, Bozeman, MT (US); Jason E. Kay, Belgrade, MT (US); Jon D. Koon, Belgrade, MT (US); Anthony J. Lukes, Bozeman, MT (US); Brett D. Swimley, Bozeman, MT (US)

Correspondence Address: DOCKET CLERK, P.O. DRAWER 800889, DALLAS, TX, 75380, US

(73) Assignee: BILLBOARD VIDEO, INC., Dallas, TX (US)

(21) Appl. No.: 11/159,817

(22) Filed: Jun. 23, 2005

Related U.S. Application Data
(60) Provisional application No. 60/610,291, filed on Sep. 16, 2004.

(51) Int. Cl. G09G 3/32

(52) U.S. Cl. 345/82

(57) ABSTRACT

An apparatus that supports operation of an LED sign includes a backplane that connects a backplane frame output of a first video data processor circuit card to a backplane frame input of a second video data processor circuit card, and also connects a backplane frame output of the second video data processor circuit card to a backplane frame input of a sign interface circuit card. Each video data processor circuit card includes a video source input, and the sign interface circuit card includes a video data output for coupling to distribution boards located at the sign. The backplane architecture provides flexible scalability by permitting the addition of further video data processor circuit cards and further sign interface circuit cards in any desired configuration.

This application claims the priority under 35 U.S.C. §119(e) of co-pending U.S. Provisional Application No. 60/610,291, filed on Sep. 16, 2004 and incorporated herein by reference.

### FIELD OF THE INVENTION

The invention relates generally to LED (light emitting diode) billboard signs and, more particularly to control and operation of LED billboard signs.

### BACKGROUND OF THE INVENTION

LED billboard signs are conventionally used for visual display applications, such as advertising billboards, stadium scoreboards, etc. LED billboard signs are constructed from LED display modules. A typical LED display module includes an array of LED pixels, each pixel including a plurality of LEDs positioned in a desired arrangement relative to one another. A typical display module might include, for example, 640 LEDs, and a typical LED billboard sign might include, for example, from 100 to as many as several thousand display modules. A control system coupled to the LED display modules of the sign appropriately activates selected LEDs at selected times, thereby causing the sign to produce a desired visual display.

One conventional LED billboard sign control system includes a PC having a PC video card and an ISA card interconnected by a video bus. The ISA card receives video data and stores it into one of a pair of frame buffers. While data is being loaded into one of the frame buffers, data from the other frame buffer is transmitted on an LVDS (low voltage differential signaling) interface to row distribution boards. Each row distribution board sends its video data to a row of distribution boards. These latter distribution boards then send their video data to driver boards which drive the LEDs of the display modules.

Another conventional LED billboard sign control system utilizes a backplane architecture. One version of the system supports six card slots, and another version supports twelve card slots. A single video input card can receive video data via OpenLDI, DVI, or Analog VGA. The system also includes a video data processor card, and several fiber optic-based video data output cards that transmit output video data to section controllers. The backplane architecture provides a common bus that is used for video data transport among all of the aforementioned cards. Each section controller sends its data to distribution boards. The distribution boards then send their data to driver boards which drive the LED display modules.

FIG. 1 diagrammatically illustrates another control system according to the prior art. The system of FIG. 1 includes a control PC, a video data processor VDP, a sign interface module SIM and a plurality of distribution boards which are designated DX2. The DX2s and the LED display blocks are included in the physical assembly of the sign itself, while the control PC and VDP can be physically located together at a considerable distance from the sign. The SIM is provided within the sign assembly or at a location separate from both the sign assembly and the control PC/VDP. The VDP receives video data from the PC, and is connected to the SIM by fiber optic cables. These fiber optic cables carry both control interface signaling and DVI video data. The VDP takes raw input video data and formats it for the sign. Video inputs for the VDP can include DVI, analog RGB, and NTSC.

The sign interface module SIM handles all control and data interfacing for the sign. The SIM receives an input video frame, preprocesses the frame, and then sends data packets via a Fast Pipe (LVDS) interface to the DX2 boards. FIG. 1 illustrates 32 Fast Pipe outputs from SIM to the DX2 boards. Through the Fast Pipe interface, the SIM configures the DX2 boards and sends video data for display on the sign. Each of the 32 Fast Pipe outputs from the SIM drives a chain of up to 16 DX2 boards. For example, Fast Pipe output #3 can drive a chain of DX2 boards designated 3.1, 3.2 . . . 3.16. The Fast Pipe interface is also used to interconnect DX2s within the chains. Cabling for the Fast Pipe interfaces can be twisted pair copper, for example, CAT-5e or CAT-6.

The SIM is the main processor of the sign. It programs the DX2s, monitors the status of the DX2s and the LED display blocks, manages color correction information, and routes video data to the appropriate DX2s. The SIM routes video data that it receives from the VDP to the appropriate location in the sign.

Each DX2 board can drive up to 16 LED display modules (blocks) via a Display Pipe (LVDS) interface as illustrated generally at 15 in FIG. 1. The primary task of the DX2 is to send data to the display modules for display. Each DX2 can handle 4,096 display pixels, which is equivalent to 1,024 enhanced physical pixels. The data transmitted to the display blocks by the DX2s can be formatted in a variety of geometries, including widths and heights of, for example, 16, 32, 64, 128 or 256 display pixels. Each DX2 has 16 Display Pipe outputs, each of which can drive up to 1,024 LEDs. Each Display Pipe output can therefore drive display pixels arranged in various geometries, for example 8×8, 16×8, 8×16, 16×16, 32×16, 16×32 or 32×32 display pixels. The Display Pipe interface is implemented using copper twisted pair cabling such as CAT-5 or better.

The DX2s control a pulse width modulation (PWM) scheme used to drive the LEDs. The DX2s can also perform color processing, making real-time color adjustments on a per-pixel basis. A gamma table allows a 16-bit intensity to be assigned to each raw color value, which permits control of contrast, thresholds and linear regions. Matrix processing allows color calibration for differences in color and intensity of individual LEDs, as well as overall color gamut and temperature.

The DX2s also provide status information, which can be transmitted back to the control PC via the Fast Pipe interface. The status information available at the DX2 includes information derived from the LED display modules. For example, the DX2 can obtain from the display modules information such as power supply status, temperature, calibration data and error conditions.

The LED display blocks each include driver circuitry and control circuitry that are mounted on the same boards as the associated LEDs.

As LED billboard signs become ever larger, with more LED pixels to be controlled, and correspondingly more image production capabilities, the design of the SIM and VDP in systems such as FIG. 1 can become more complicated. It is therefore desirable to provide an LED billboard sign control system architecture that is flexibly adaptable to changes in the physical size and configuration of the LED billboard sign.

### SUMMARY OF THE INVENTION

Exemplary embodiments of the invention provide an apparatus that supports operation of an LED sign. A backplane connects a backplane frame output of a first video data processor circuit card to a backplane frame input of a second video data processor circuit card, and also connects a backplane frame output of the second video data processor circuit card to a backplane frame input of a sign interface circuit card. Each video data processor circuit card includes a video source input, and the sign interface circuit card includes a video data output for coupling to distribution boards located at the sign. The backplane architecture provides flexible scalability by permitting the addition of further video data processor circuit cards and further sign interface circuit cards in any desired configuration. The backplane can also support a plurality of video data output circuit cards that can drive a video display monitor. For further flexible scaling capabilities, the backplane can be connected to one or more other backplanes that are suitably configured with any desired combination(s) of video data processor circuit cards, sign interface circuit cards and video data output circuit cards.

Before undertaking the Detailed Description of the Invention, it may be advantageous to set forth a definition of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, coupled to or with, be communicable with, cooperate with, interleave, juxtapose, be proximate to, be bound to or with, have, have a property of, or the like; the term “memory” means any storage device, combination of storage devices, or part thereof whether centralized or distributed, whether locally or remotely; and the terms “controller,” “processor” and “allocator” mean any device, system or part thereof that controls at least one operation, such a device, system or part thereof may be implemented in hardware, firmware or software, or some combination of at least two of the same.

It should be noted that the functionality associated with any particular controller or allocator may be centralized or distributed, whether locally or remotely. In particular, a controller or allocator may comprise one or more data processors, and associated input/output devices and memory that execute one or more application programs and/or an operating system program.

Additional definitions for certain words and phrases are provided throughout this patent document, those of ordinary skill in the art should understand that in many, if not most instances, such definitions apply to prior uses, as well as to future uses, of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 diagrammatically illustrates an LED billboard sign apparatus according to the prior art.

FIG. 2 diagrammatically illustrates an LED billboard sign apparatus according to exemplary embodiments of the invention.

FIG. 3 diagrammatically illustrates the I/O integrator of FIG. 2 in more detail according to exemplary embodiments of the invention.

FIG. 4 diagrammatically illustrates the backplane architecture of FIG. 3 in more detail according to exemplary embodiments of the invention.

FIG. 5 diagrammatically illustrates exemplary embodiments of the video input cards of FIGS. 3 and 4 according to the invention.

FIG. 6 diagrammatically illustrates exemplary embodiments of the video output cards of FIGS. 3 and 4 according to the invention.

FIG. 7 diagrammatically illustrates exemplary embodiments of the sign interface cards of FIGS. 3 and 4 according to the invention.

FIG. 8 diagrammatically illustrates in more detail the LED sign of FIG. 2 and its link to the I/O integrator according to exemplary embodiments of the invention.

### DETAILED DESCRIPTION

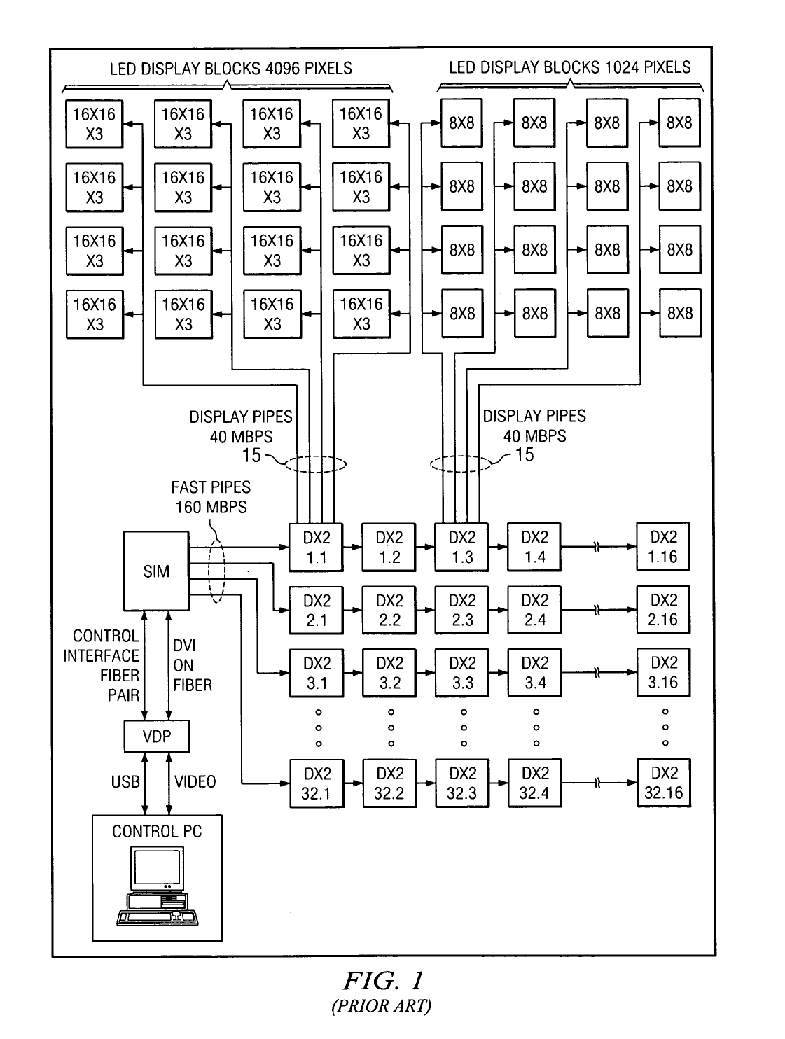

FIGS. 1 through 8, discussed herein, and the various embodiments used to describe the principles of the present invention in this patent document, are by way of illustration only and should not be construed in any way to limit the scope of the invention. Those skilled in the art will understand that the principles of the present invention may be implemented in any suitably arranged LED sign apparatus.

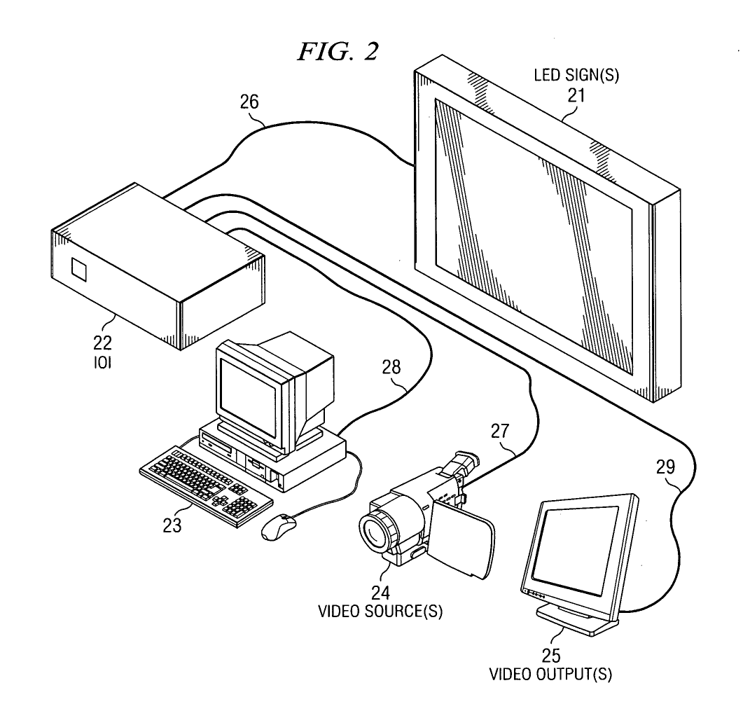

FIG. 2 diagrammatically illustrates an LED billboard sign apparatus according to exemplary embodiments of the invention. The apparatus of FIG. 2 includes one or more LED signs, designated generally at 21, coupled at 26 to an I/O integrator (IOI) 22. In some embodiments, the LED sign at 21 includes LED display modules such as shown in FIG. 1, and also provides the functionality of the DX2 boards of FIG. 1. In some embodiments, the IOI 22 provides the functionality of the VDP and SIM of FIG. 1.

The IOI 22 is coupled at 28 to a PC controller 23, is also coupled at 27 to one or more video sources designated generally at 24, and is also coupled at 29 to one or more video output displays designated generally at 25. In various embodiments, all of the components at 22-25 can be located physically remotely from the sign 21, any desired combination of the components at 22-25 can be provided at a single physical location, and various ones of the components at 22-25 can be located physically remotely from one another as desired.

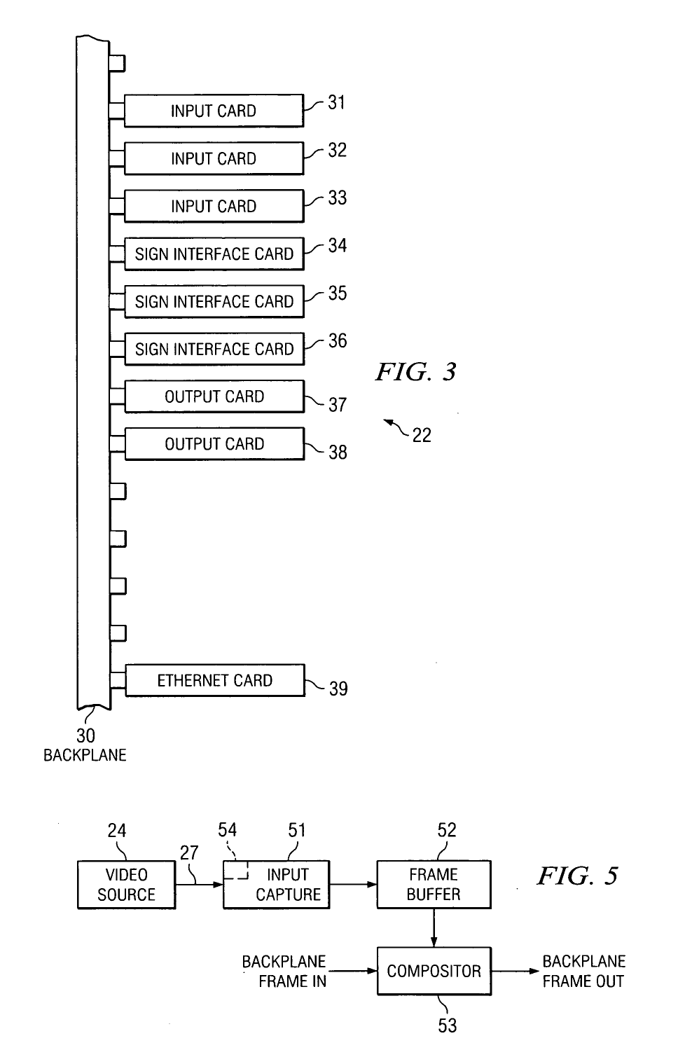

FIG. 3 diagrammatically illustrates a portion of the IOI 22 of FIG. 2 in more detail according to exemplary embodiments of the invention. As shown in FIG. 3, the IOI 22 implements a backplane architecture wherein a backplane chassis 30 is utilized to transport video data between adjacent circuit cards. In FIG. 3, the backplane chassis 30 is connected to a plurality of video input cards 31-33, a plurality of sign interface cards 34-36, a plurality of video output cards 37 and 38, and an Ethernet card 39. Video data arranged in a backplane frame format can be transported in point-to-point fashion among the cards 31-38. Such point-to-point transfer of backplane frames is known in the art.

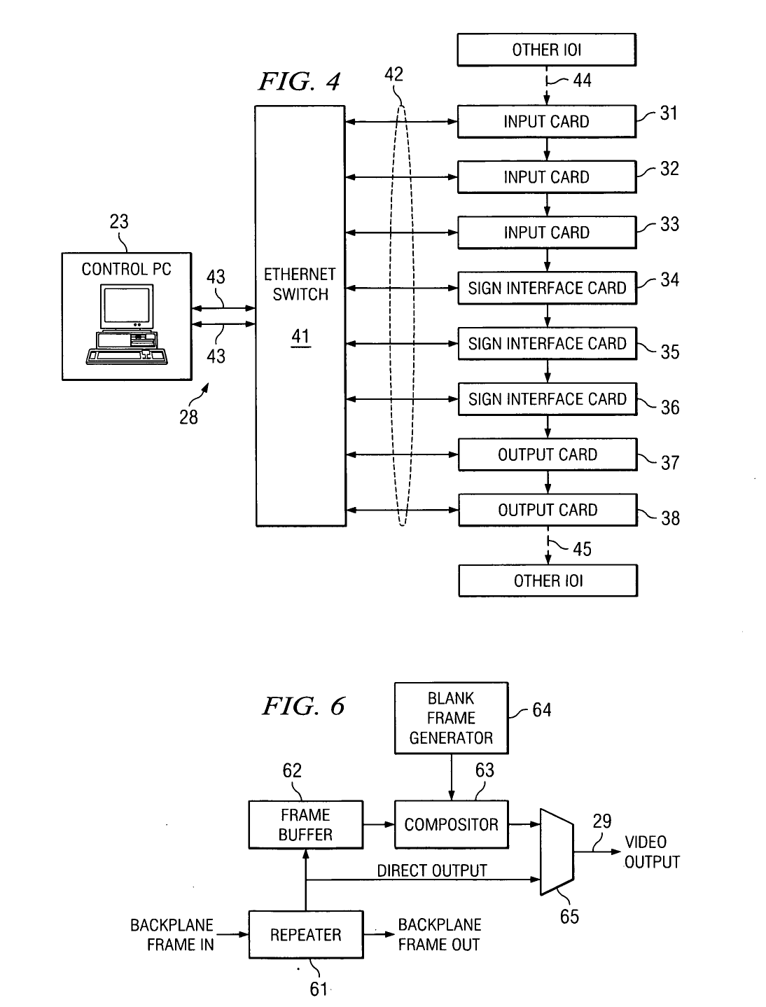

FIG. 4 diagrammatically illustrates the backplane architecture of FIG. 3 in more detail according to exemplary embodiments of the invention. FIG. 4 illustrates the point-to-point video transport mechanism supported by the backplane architecture. As illustrated in FIG. 4, the backplane chassis 30 interconnects the circuit cards 31-38 to create a point-to-point stack transport mechanism wherein a frame created by the first input circuit card 31 at the top of the stack progressively passes through all of the rest of the circuit cards 32-38 in the stack implemented by the backplane chassis 30. Referring again to FIG. 3, the Ethernet circuit card 39 is not included in the stack of FIG. 4. The use of the Ethernet card 39 will be described in more detail below.

Architecturally, the cards 31-38 are connected in a daisy-chain fashion as a stack. Each card receives data from the card before it in the stack and sends data to the card after it in the stack. As the video data passes through each card in the stack, the card can use the video data, add to the video data, or modify the video data. For example, the input cards 31-33 will typically add to the video data stream. The sign interface cards 34-36 will typically use the video data and also pass the video data unmodified to the next card in the stack.

In some embodiments, the video data bandwidth associated with the backplane architecture is 7.92 Gbps and there are a total of 40 bits per pixel. At 7.92 Gbps, the backplane chassis can support 198 million pixels per second. The backplane frame of video data that passes through the stack of FIG. 4 can take on various different shapes and sizes to support different sign configurations. Although the configuration of the backplane frame need not match the configuration of the sign 21 (see also FIG. 2) exactly, it does need to be large enough (both horizontally and vertically) to store the images that will be displayed on the sign. Some embodiments support the following exemplary backplane frame resolutions at 60 Hz: 1,024 pixels horizontally by 3200 pixels vertically; 2,048 pixels horizontally by 1600 pixels vertically; 4,096 pixels horizontally by 800 pixels vertically; and 8,196 pixels horizontally by 400 pixels vertically.

The vertical sync of the frames on the backplane is referred to herein as the master vertical sync. In some embodiments, the master vertical sync free-runs at the selected frequency. In other embodiments, the master vertical sync can be locked to the vertical sync from a selected one of the video input cards. In some applications, it is desirable to lock the master vertical sync to the video source 24 being used by the sign (see also FIG. 2), or to the primary video source if more than one video source is being used, such as with picture-in-picture applications.

FIG. 4 also illustrates that, in some embodiments, the backplane chassis 30 provides for Ethernet communications to and from each of the cards at 31-38. As used herein, “Ethernet” refers generally to any LAN technology that conforms to or is functionally compatible with the well-known Ethernet standard, including, for example, such well-known versions as Fast Ethernet and Gigabit Ethernet. In some embodiments, the backplane chassis includes all of the functionality of an Ethernet switch (for example a 10/100 switch) as illustrated generally at 41. In some embodiments, the Ethernet switch 41 includes a port for each card slot in the backplane 30. These ports are illustrated generally at 42 in FIG. 4. In such embodiments, each of the cards 31-38 is simply a device on an Ethernet network. In the example of FIG. 4, the Ethernet switch 42 also includes two external ports, designated generally at 43, for communicating with the control PC 23.

FIG. 4 also illustrates that any given IOI 22 can be connected in daisy-chain fashion to another IOI 22. As shown in FIG. 4, the output card 38 of a given IOI 22 can be connected to the input card 31 of another IOI 22. In some embodiments, the daisy-chain connection between the output card 38 of a first IOI 22 and the input card 31 of a second IOI 22 is implemented using a conventional DVI cable, as illustrated by broken lines at 44 and 45 in FIG. 4.

FIG. 5 diagrammatically illustrates exemplary embodiments of the input cards 31-33 of FIG. 3 and 4 according to the invention. The input cards perform the function of an input video processor. The input card of FIG. 5 receives two video data inputs, video data from a video source 24, and the backplane frame. The input video data received from the video source (via backplane chassis 30) is captured by an input capture circuit block 51, and is stored temporarily in a frame buffer 52. The video data from the frame buffer 52 is input to a compositor 53, which also receives the backplane frame as an input. The compositor 53 effectuates the adding of the video data received from the video source to the backplane frame. The compositing operation can be performed using conventional techniques to implement any desired compositor algorithm. Various embodiments utilize compositor algorithms such as Z-layering, chroma-keying, picture-in-picture, and blending. Different ones of the cards 31-33 can implement different compositor algorithms as desired.

In some embodiments, the input capture circuit 51 is capable of processing input video data in various conventionally available formats, such as DVI, analog RGB, NTSC, S-Video and HDTV. With these types of video data inputs, the input capture circuit 51 can use conventional techniques to convert the input video data format into a standard digital frame format. This conversion process will vary depending on the input video data format, but the result is a digital image to be stored in the frame buffer 52 for each frame that comes in. In some embodiments, the frame buffer 52 is a triple-frame buffer which facilitates synchronizing the video source input and backplane frame input with one another at the compositor 53. The result of the compositing operation performed by the compositor 53 is provided as the backplane frame output.

Referring also to FIG. 3, some embodiments utilize the Ethernet card 39 to permit the use of Ethernet as an input video source at 24 in FIG. 5 (see also FIG. 2). For example, using gigabit-Ethernet, data can be generated by an input video source 24 such as a PC. The Ethernet card 39 of FIG. 3 can implement a suitable Ethernet switch coupled to the input Ethernet video source 24 via the backplane 30, and also coupled via backplane 30 to the input capture circuit 51 of the input card of FIG. 5. Input cards that use Ethernet as a video source include two Ethernet ports, one Ethernet port for communication with the Ethernet switch 41 and control PC 23, as shown at 42 in FIG. 4, and a further Ethernet port (e.g., at 54 in the input capture circuit 51) for communicating with the input Ethernet video source 24 via the Ethernet card 39 of FIG. 3.

In video input cards that utilize Ethernet as an input video source, the input capture circuitry illustrated generally at 51 in FIG. 5 implements a conventional Ethernet interface, shown generally at 54. By using Ethernet as a video input source, the video input data need not conform to any predetermined video standard. This permits many uses, from simple applications such as text overlays for time and temperature to more sophisticated applications such as scrolling tickers. Using a suitable video command set, gigabit-Ethernet video data can be transferred into the input frame buffer 52.

FIG. 6 diagrammatically illustrates in more detail the video output cards of FIGS. 3 and 4 according to exemplary embodiments of the invention. The video output cards 37 and 38 perform the function of an output video processor, and are used to view the composited video in the backplane frame. This allows an operator of the control PC 23 to use the video output display(s) 25 (see also FIG. 2) to view the image(s) being used by the sign. As mentioned above, the output cards can also be used to daisy-chain one IOI 22 to another IOI 22 (see also FIG. 4).

As shown in FIG. 6, an output card receives the backplane frame as an input, and a repeater 61 permits the output card to output the received backplane frame to the next card in the stack (or to another IOI 22). The repeater 61 also permits the backplane frame input to be routed into a frame buffer 62 for temporary storage. The backplane frames in the frame buffer are input to a compositor 63 whose other input receives a blank frame from a blank frame generator 64. The compositor 63 can utilize conventional compositor algorithms to produce an output that basically represents the backplane frame composited onto a blank frame. A selector 65 permits either the output of compositor 63 or the received backplane frame input to be provided at 29 as the video output data from the output card.

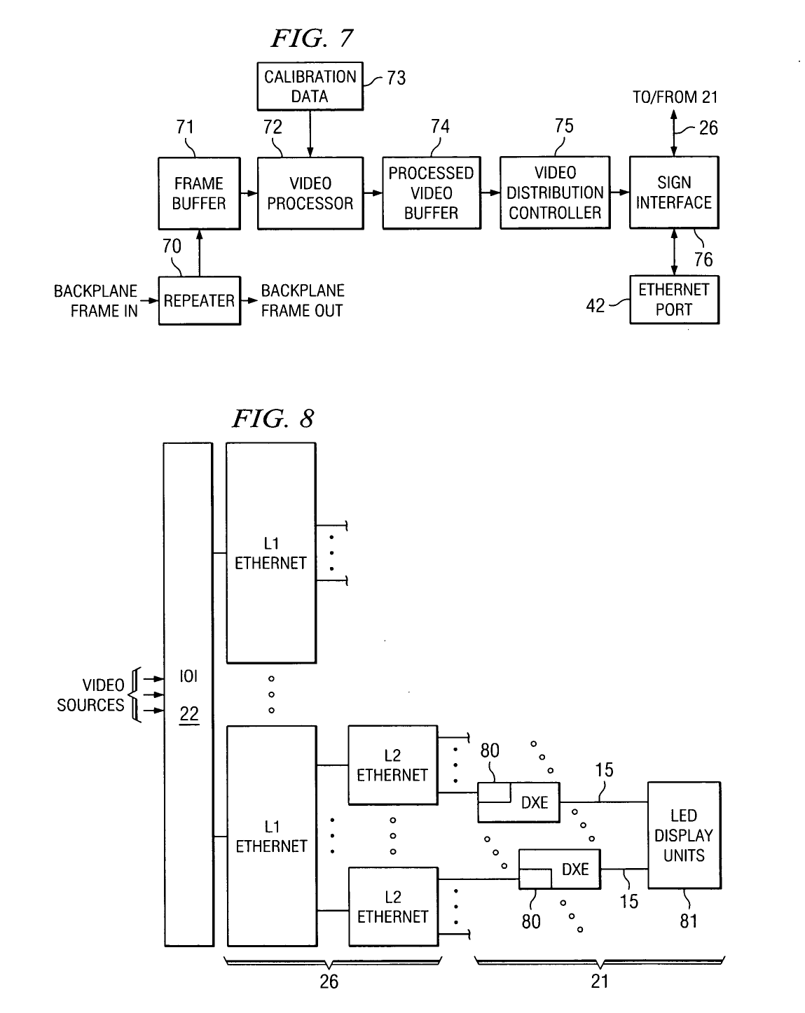

FIG. 7 diagrammatically illustrates in more detail exemplary embodiments of the sign interface cards of FIGS. 3 and 4 according to the invention. In some embodiments, any one of the sign interface cards 34-36 can function as a sign interface unit that performs generally the same sign interface module functions as are performed by the SIM described above relative to FIG. 1. The sign interface cards transmit to the sign 21 (see also FIG. 2) video data selected from the backplane frame. As shown in FIG. 7, a repeater 70 permits the input backplane frame to be output to the next card in the backplane stack. The repeater 70 also provides the input backplane frame to a frame buffer 71 for temporary storage. A video processor 72 receives the frames from the frame buffer 71, and utilizes conventional techniques to process those frames based on conventionally obtained calibration data 73. The processed frames produced by the video processor 72 are temporarily stored in a buffer 74, and the frames stored in the buffer 74 are ultimately input to a video distribution controller 75. The video distribution controller 75 uses conventional techniques to ensure that the video data is routed to the appropriate distribution boards in the sign 21.

The output of the video distribution controller 75 is provided as an input to a sign interface 76, which in turn interfaces the video data received from video distribution controller 75 to the communication link 26 that couples the IOI 22 to the sign 21 (see also FIG. 2). The sign interface 76 is also coupled to the Ethernet port 42 (see also FIG. 4) of the sign interface card, thereby permitting bidirectional communication between the control PC 23 and the sign 21, via Ethernet switch 41, Ethernet port 42, sign interface 76 and communication link 26. In some embodiments, the sign interface 76 implements the Fast Pipe interface, and the sign interface card transmits data to DX2 boards at the sign in generally the same manner described above with respect to FIG. 1. In other embodiments, the sign interface 76 implements an Ethernet interface.

FIG. 8 diagrammatically illustrates exemplary embodiments of an LED billboard sign apparatus according to the invention. In the apparatus of FIG. 8, the communication link 26 between the IOI 22 and the sign 21 is an Ethernet link. The Ethernet link 26 includes a Layer 1 Ethernet switch L1, and a plurality of Layer 2 Ethernet switches L2. In some embodiments, the switch L1 includes a gigabit-Ethernet port coupled to the sign interface 76 (which also includes a gigabit-Ethernet port) of a sign interface card within the IOI 22. In various embodiments, the remaining (e.g., 7 or 15) ports of the switch L1 are gigabit or 100 base T. As shown in FIG. 8, these remaining ports are respectively coupled to corresponding ports of the Layer 2 switches L2. In some embodiments, all ports of the Layer 2 switches L2 are 100 base T, each switch L2 having one port coupled to the associated Layer 1 switch L1, and having its remaining (e.g., 7 or 15) ports respectively coupled to corresponding distribution boards at the sign 21, which distribution boards are designated by DXE in FIG. 8.

In some embodiments, the distribution boards DXE implement the same video data distribution functionality as the conventional distribution boards DX2 described above with respect to FIG. 1. However, the distribution boards DXE differ from the distribution boards DX2 in that the distribution boards DXE include Ethernet ports 80 for interfacing to the Ethernet switches L2 in the communication link 26. In some embodiments which utilize Ethernet to implement the communication link 26, the video data transmitted by the sign interface card of FIG. 7 includes the same data packets as are transmitted by the SIM to the DX2s of FIG. 1. The sign interface 76 of FIG. 7 encapsulates those data packets according to the Ethernet protocol, and the Ethernet ports of the DXE boards de-encapsulate the Ethernet packets and forward the resulting data packets to the DX2 video data distribution functionality of the DXE boards. This DX2 video data distribution functionality then utilizes the Display Pipe interfaces 15 of FIG. 1 to distribute video data to LED display units 81, for example the LED display blocks described above with respect to FIG. 1.

FIG. 8 also illustrates generally at 82 that a plurality of sign interface cards such as shown in FIGS. 3, 4 and 7 can support respective ones of a plurality of Ethernet communication links 26, and corresponding groups of DXE boards in one or more signs 21. In such embodiments, each sign interface card of the IOI 22 is coupled to a respectively corresponding Ethernet switch L1, and the corresponding communication link 26 and sign 21 are implemented in generally the same fashion as described above relative to FIG. 8.

The use of Ethernet to support the communication link 26 provides substantially higher bandwidth than does the Fast Pipe interface of FIG. 1. This additional bandwidth supports higher rates of video data transfer. In some embodiments, the added bandwidth permits the video processor 72 of the sign interface card of FIG. 7 to implement the aforementioned gamma table before data transmission to the DXEs, so the DXEs need not include gamma table functionality. In some embodiments, the cabling for the Ethernet-based communication link 26 includes Cat-6 cabling. Other embodiments use fiber optic cabling.

In some embodiments, any one or more of the above-described instances of Ethernet technology can be replaced by another suitable LAN architecture.

The above-described embodiments are capable of providing a plurality of sign interface cards on a backplane. This type of architecture is readily scalable, by adding more sign interface cards, to support several and/or very large LED billboard signs. Similarly, the capability of providing a plurality of video input cards on a backplane provides a highly flexible video input capability that scales to support multiple and varied video inputs, with correspondingly multiple and varied compositing capabilities and compositing combinations. The capability of providing a plurality of video output cards on a backplane provides similarly flexible, scalable output options. All of the advantages associated with the ability to provide pluralities of video input cards, sign interface cards and video output cards on a backplane, in any desired configuration, can clearly be further enhanced by embodiments that daisy-chain together the backplanes of more than one IOI 22, with each backplane configured as desired.

The foregoing has outlined the features and technical advantages of the present invention so that those skilled in the art may understand the invention. Those skilled in the art should appreciate that they may readily use the conception and the specific embodiments disclosed as a basis for modifying or designing other structures for carrying out the same purposes of the present invention. Those skilled in the art should also realize that such equivalent constructions do not depart from the spirit and scope of the invention in its broadest form.

What is claimed is:

1. An apparatus for supporting operation of an LED sign, comprising:
a video data processor including first and second video data processor circuit cards, each having a video source input, a backplane frame input and a backplane frame output;
a sign interface unit for routing video data to a plurality of distribution boards that are provided within an LED sign and are connected to respectively corresponding pluralities of LED drivers that drive LEDs in the sign, said sign interface unit including a sign interface circuit card having a backplane frame input, and having a video data output for coupling to the associated distribution boards; and
a backplane chassis connected to said first and second video data processor circuit cards and said sign interface circuit card, said backplane chassis coupling said backplane frame output of said first video data processor circuit card to said backplane frame input of said second video data processor circuit card, said backplane chassis also coupling said backplane frame output of said second video data processor circuit card to said backplane frame input of said sign interface circuit card.

2. The apparatus of claim 1, wherein said sign interface circuit card includes a backplane frame output connected to said backplane chassis.

3. The apparatus of claim 2, including a further sign interface unit for routing video data to a plurality of distribution boards that are provided within an LED sign and are connected to respectively corresponding pluralities of LED drivers that drive LEDs in the sign, said further sign interface unit including a further sign interface circuit card connected to said backplane chassis, said further sign interface circuit card having a backplane frame input, and having a video data output for coupling to the associated distribution boards, said backplane chassis coupling said backplane frame input of said further sign interface circuit card to said backplane frame output of said first-mentioned sign interface circuit card.

4. The apparatus of claim 2, including a further video data processor, said further video data processor including a further video data processor circuit card having a backplane frame input and a video data output, said further video data processor circuit card connected to said backplane chassis, said backplane chassis coupling said backplane frame input of said further video data processor circuit card to said backplane frame output of said sign interface circuit card, said video data output of said further video data processor circuit card for coupling to a video monitor.

5. The apparatus of claim 1, wherein said backplane chassis includes an Ethernet switch, said video data processor circuit cards and said sign interface circuit card each including an Ethernet port, said backplane chassis coupling said Ethernet switch to said Ethernet ports, and said Ethernet switch including a port for coupling to an external controller.

6. The apparatus of claim 5, wherein said video source input of one of said video data processor circuit cards includes an Ethernet port, and including a further circuit card connected to said backplane chassis, said further circuit card including an Ethernet switch, and said backplane chassis coupling said Ethernet switch of said further circuit card to said Ethernet port of said video source input of said one video data processor circuit card.

7. The apparatus of claim 6, wherein said video data output of said sign interface circuit card includes a further Ethernet port.

8. The apparatus of claim 5, wherein said video data output of said sign interface circuit card includes a further Ethernet port.

9. The apparatus of claim 1, wherein said video data output of said sign interface circuit card includes an Ethernet port.

10. The apparatus of claim 1, wherein said video source input of one of said video data processor circuit cards includes an Ethernet port, and including a further circuit card connected to said backplane chassis, said further circuit card including an Ethernet switch, and said backplane chassis coupling said Ethernet switch of said further circuit card to said Ethernet port of said video source input of said one video data processor circuit card.

11. The apparatus of claim 10, wherein said video data output of said sign interface circuit card includes a further Ethernet port.

12. The apparatus of claim 1, wherein said backplane chassis is configured to implement among said circuit cards a card-to-card video data transport mechanism.

13. An LED sign apparatus, comprising:
a plurality of distribution boards;
a plurality of LED display units, each said LED display unit including a plurality of LEDs and a plurality of LED drivers connected to drive said LEDS;
said distribution boards coupled to respectively corresponding groups of said LED drivers;
a video data processor including first and second video data processor circuit cards, each having a video source input, a backplane frame input and a backplane frame output;
a sign interface unit that routes video data to said distribution boards, said sign interface unit including a sign interface circuit card having a backplane frame input, and having a video data output coupled to said distribution boards; and
a backplane chassis connected to said first and second video data processor circuit cards and said sign interface circuit card, said backplane chassis coupling said backplane frame output of said first video data processor circuit card to said backplane frame input of said second video data processor circuit card, said backplane chassis also coupling said backplane frame output of said second video data processor circuit card to said backplane frame input of said sign interface circuit card.

14. The apparatus of claim 13, including an Ethernet communication link coupling said distribution boards to said video data output of said sign interface circuit card.

15. The apparatus of claim 14, wherein said Ethernet communication link includes a first Ethernet switch having a port coupled to said video data output of said sign interface circuit card, and having a plurality of further ports, said Ethernet communication link including a plurality of further Ethernet switches, each of said further Ethernet switches having a port coupled to one of said plurality of further ports of said first-mentioned Ethernet switch, and each of said further Ethernet switches having a plurality of further ports, each of said distribution boards including an Ethernet port coupled to one of said further ports of said further Ethernet switches.

16. The apparatus of claim 13, wherein said sign interface circuit card includes a backplane frame output connected to said backplane chassis.

17. The apparatus of claim 16, including a further sign interface unit for routing video data to a plurality of distribution boards that are provided within an LED sign and are connected to respectively corresponding pluralities of LED drivers that drive LEDs in the sign, said further sign interface unit including a further sign interface circuit card connected to said backplane chassis, said further sign interface circuit card having a backplane frame input, and having a video data output for coupling to the associated distribution boards, said backplane chassis coupling said backplane frame input of said further sign interface circuit card to said backplane frame output of said first-mentioned sign interface circuit card.

18. The apparatus of claim 16, including a further video data processor, said further video data processor including a further video data processor circuit card having a backplane frame input and a video data output, said further video data processor circuit card connected to said backplane chassis, said backplane chassis coupling said backplane frame input of said further video data processor circuit card to said backplane frame output of said sign interface circuit card, said video data output of said further video data processor circuit card for coupling to a video monitor.

19. The apparatus of claim 13, wherein said backplane chassis is configured to implement among said circuit cards a card-to-card video data transport mechanism.

20. The apparatus of claim 13, wherein each of said distribution boards includes an Ethernet port.
